(19) United States
(12) Patent Application Publication
(10) Pub. No.: US 2005/0036869 A1
(43) Pub. Date: Feb. 17, 2005

(54) Vehicle hauling apparatus

(76) Inventor: Carl Negranti, Cambria, CA (US)

Correspondence Address: SINSHEIMER, SCHIEBELHUT, BAGGETT, 1010 PEACH STREET, SAN LUIS OBISPO, CA, 93401, US

(21) Appl. No.: 10/637,784

(22) Filed: Aug. 8, 2003

(51) Int. Cl. B60P 1/00

(52) U.S. Cl. 414/537

(57) ABSTRACT

This invention relates generally to a hauling apparatus for transporting vehicles. In a preferred embodiment, the hauling apparatus transports four-wheeled recreational and utility vehicles, such as All-Terrain Vehicles (ATV), golf carts, riding lawnmowers, garden tractors, and personal vehicles for the handicapped. The vehicle hauling apparatus of the preferred embodiment connects to a standard receiving hitch of a towing vehicle, wherein the horizontal center of said vehicle hauling apparatus is substantially parallel to the horizontal center of a hauling vehicle.

### BACKGROUND OF THE INVENTION

1. Field of the Invention

This invention relates generally to a hauling apparatus for transporting vehicles, such as, for example, recreational and/or utility vehicles.

2. Discussion of the Related Art

Recreational and utility vehicles are commonly transported in the bed of a pickup truck or by a wheeled trailer pulled behind a towing vehicle. However, by transporting recreational and/or utility vehicles in the bed of a pickup truck, space available for carrying other gear is significantly reduced. In the case of wheeled trailers pulled behind a towing vehicle, additional friction caused by the trailer wheels reduces gas mileage and inherently subjects the towing vehicle, and trailer, to dangerous “sway” on roadways. Furthermore, recreational and/or utility vehicles are frequently used in remote areas that are at times difficult to reach. In these cases, a wheeled trailer may be subject to severe jarring which may cause significant damage to any or all of the towing vehicle, trailer, and recreational and/or utility vehicle.

Previously contemplated devices to obviate these and other problems have been developed, such as the hauling devices described in U.S. Pat. No. 4,934,894 of White as well as the apparatus described in US Patent Application Publication US 2002/0154980 of Potts. Wright teaches a tiltable hauling device positioned laterally at the rear of a passenger vehicle. However, the device contemplated by Wright is disadvantageously bulky and complicated with numerous mechanical features. The additional mechanical parts and loading platform taught by Wright add increased weight to the hauling device, thus increasing tongue weight and, therefore, strain on the towing vehicle. Additionally, the lateral design of the device renders on-loading and off-loading of a recreational vehicle cumbersome. Potts describes a pivoting ramp device for loading and transporting a motorcycle. The device contemplated by Potts has a single ramp member positioned laterally at the rear of the hauling vehicle. Therefore, hauling a four-wheeled vehicle is impossible with this device.

The present invention addresses the above and other needs.

### SUMMARY OF THE INVENTION

This invention relates generally to a hauling apparatus for transporting vehicles. In a preferred embodiment, the hauling apparatus transports four-wheeled recreational and utility vehicles, such as All-Terrain Vehicles (ATV), golf carts, riding lawnmowers, garden tractors, and personal vehicles for the handicapped. The vehicle hauling apparatus of the preferred embodiment connects to a standard receiving hitch of a towing vehicle, wherein the center of the vehicle hauling apparatus lies along the medial plane of the towing vehicle.

In one embodiment, the invention consists generally of at least one ramp member (e.g. a first ramp member and a second ramp member), a beam member situated in a parallel plane to the at least one ramp member, a swivel shaft sleeve, a moveable swivel shaft, and a hitching means. The swivel shaft sleeve may be fastened to the beam member. The moveable swivel shaft may be inserted rotatably through the swivel shaft sleeve, wherein the moveable swivel shaft is coupled to the at least one ramp member such that the ramp members and the moveable swivel shaft pivot as a group relative to the beam member. The hitching means may coupled to the beam member such that the horizontal center of the vehicle hauling apparatus is substantially parallel to the horizontal center of a hauling vehicle (i.e. lies along the medial plane of the towing vehicle).

Furthermore, the invention contemplates several mechanisms for locking a recreational and/or utility vehicle into the vehicle hauling apparatus in a substantially horizontal position above ground, such as, for example, a spring mechanism and a swivel lock mechanism.

### BRIEF DESCRIPTION OF THE DRAWINGS

The above mentioned and other objects and features of this invention and the manner of attaining them will become apparent, and the invention itself will be best understood by reference to the following description of the embodiments of the invention in conjunction with the accompanying drawings, wherein:

FIG. 1 is a drawing of a vehicle hauling apparatus with a spring mechanism shown in perspective view;

FIG. 2 is an illustration of the vehicle hauling apparatus of FIG. 1 shown in top view;

FIG. 3 is a depiction of the spring provided in FIG. 1 in an up-close view;

FIG. 4 is a drawing of the vehicle hauling apparatus of FIG. 1 displayed in end view;

FIG. 5A is a drawing of the vehicle hauling apparatus of FIG. 1 shown in side elevational view;

FIG. 5B is an illustration detailing the pivot region of the vehicle hauling apparatus of FIG. 5A in side view;

FIG. 6 is a representation of the vehicle hauling apparatus of FIG. 1 with a recreational vehicle loaded thereto shown in side elevational view;

FIG. 7 is a representation of the vehicle hauling apparatus of FIG. 1 with a recreational vehicle in the process of being on-loaded or off-loaded shown in side elevational view;

FIG. 8 is a drawing of a vehicle hauling apparatus with a pivot lock mechanism shown in perspective view;

FIG. 9 is a depiction of the swivel lock mechanism provided in FIG. 8 in an up-close view;

FIG. 10 is a representation of the vehicle hauling apparatus of FIG. 8 with a recreational vehicle loaded thereto shown in side elevational view; and

FIG. 11 is a representation of the vehicle hauling apparatus of FIG. 8 with a recreational vehicle in the process of being on-loaded or off-loaded shown in side elevational view.

### DETAILED DESCRIPTION OF THE PREFERRED EMBODIMENTS

The following description is of the best mode presently contemplated for practicing the invention. This description is not to be taken in a limiting sense, but is made merely for the purpose of describing the general principles of the invention. The scope of the invention should be ascertained with reference to the issued claims. In the description that follows, like numerals or reference characters will be used to refer to like parts or elements throughout.

The vehicle hauling apparatus of the preferred embodiment may haul numerous types of four-wheeled recreational and utility vehicles such as ATV's, golf carts, riding lawnmowers, garden tractors, and personal vehicles for the handicapped. In an alternative embodiment, the vehicle hauling apparatus may also be adapted to haul two-wheeled vehicles such as motorcycles, dirt bikes, and bicycles. The apparatus may advantageously accommodate several two-wheeled vehicles.

The vehicle hauling apparatus of the present embodiment attaches to a towing vehicle/hauling vehicle, such as, for example, a pickup truck, sports utility vehicle (SUV), van, camper, full-sized automobile, and any other type of vehicle sufficiently sturdy to withstand the towing strain/hauling strain accompanied with towing/hauling various types of recreational and utility vehicles. For example a large passenger vehicle, such as a heavy duty pickup truck, camper, heavy duty van, or heavy duty SUV, may be better suited to haul a large ATV than a full-sized sedan or small SUV.

The hauling apparatus couples with a vehicle via a standard receiving tow hitch. The receiving tow hitch utilized should be chosen based on the specifications of the recreational and/or utility vehicle to be hauled.

The following are descriptions of commonly used receiving hitches:
Class I hitch—fits all vehicles and can withstand up to 200 lbs. tongue weight.
Class II hitch—fits mid-sized cars, trucks, vans, and SUV's and can withstand up to 350 lbs. tongue weight.
Class III hitch—fits mid-sized pickups, vans, and SUV's and can withstand up to 500 lbs. tongue weight.
Class IV hitch—fits full-size cars, pickups, vans, and SUV's and can withstand up to 1,200 lbs. tongue weight.
   Therefore, for an ATV weighing approximately 600 lbs. a Class IV hitch should be utilized. As many types of recreational and utility vehicles range in weight from about 400 to 700 lbs., a Class IV hitch is the preferred hitch for use with the present embodiment. For example, riding mowers generally weigh about 400-550 lbs., ATV's generally weigh about 400-600 lbs., and garden tractors generally weigh about 600-700 lbs. Although, as previously described, many recreational and utility vehicles range from 400 to 700 lbs., vehicles of other weights are also contemplated for hauling by the present embodiment. In a preferred embodiment, the hauling apparatus carries any weight from 0 to approximately 1000 lbs, e.g. 0 to 650 lbs.

A recreational and/or utility vehicle hauled using the preferred embodiment described herein is easily on-loaded by driving (or otherwise pushing and/or pulling) the recreational and/or utility vehicle onto two ramp members. As the weight of the vehicle moves forward, e.g. towards the towing vehicle, the back ends of the ramp members lift off the ground and reach a plane substantially horizontal and parallel to the ground. Using the easy to actuate locking mechanisms of the preferred embodiment, the vehicle rests securely on the hauling apparatus, above ground. The axis of the hauling apparatus lies advantageously along the medial plane (i.e. horizontal center) of the towing vehicle axis. Furthermore, as the hauled vehicle (e.g. a recreational and/or utility vehicle) is loaded either front end to back end or back end to front end along the axis running halfway between the left wheels and the right wheels of the towing vehicle, the recreational and/or utility vehicle's weight is centered about the towing vehicle's axis, albeit in the rear of the towing vehicle.

Several mechanisms are contemplated for locking a recreational and/or utility vehicle into the vehicle hauling apparatus in a substantially horizontal position above ground. For example, in one embodiment high tensile springs are coupled between a stationary piece and a rotating piece such that when the hauling apparatus is vacant the loading end of ramp members rests on the ground. As a vehicle is loaded onto the vehicle hauling apparatus, weight is initially disproportionately centered at the end of ramp members so that the ramp members stay resting on the ground. However, as the vehicle moves closer to the front of the hauling apparatus, weight moves up along the median axis causing the springs to rotate forward, thereby lifting the back end of the hauling apparatus and vehicle off the ground at a horizontal plane above the ground. In another embodiment, a swivel locking means (e.g. a swivel lock mechanism) is contemplated to secure the hauling apparatus in place. In case of the swivel lock mechanism, the swivel lock mechanism is likewise coupled between a stationary piece and a rotating piece. The swivel lock mechanism can be manually actuated to lock the ramp members in any position. However, in a preferred embodiment, the on-loaded position is in a substantially parallel plane above ground while the off-loaded position is at an angle such that the rear of the vehicle hauling apparatus rests on the ground.

Standard trailer equipment such as, for example, taillights, reflectors, license plate mounts, chains, winches, locking mechanisms, backup lights and the like are contemplated for use with the vehicle hauling apparatus described herein.

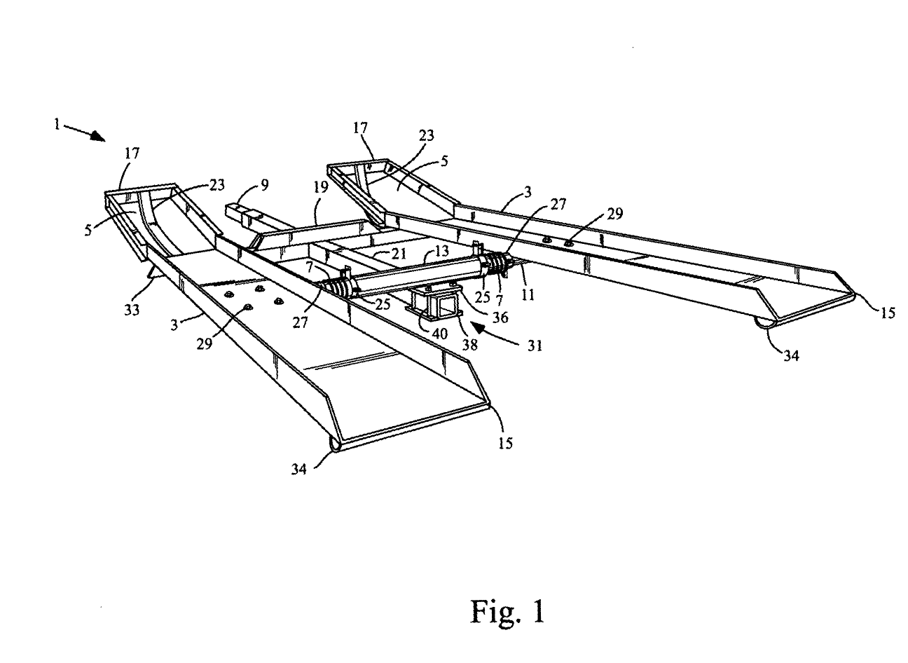

Referring now to the drawings, the features and embodiments are now further described. In FIG. 1 a perspective view of a vehicle hauling apparatus 1 with springs 7 is depicted. Shown are the vehicle hauling apparatus 1, ramp members 3, recesses 5, springs 7, a hitching means 9, a perpendicular swivel cross-shaft 11, a swivel cross-shaft sleeve 13, rear ends of ramp members 15, front ends of ramp members 17, a perpendicular stationary cross-beam 19, a parallel cross-beam 21, recess cross-bars 23, inner securing means 25, outer securing means 27, ramp member securing means 29, beam securing means 31, a ramp member extension 33, ramp member resting portions 34, upper metal piece 36, lower metal piece 38, and bolts 40.

Two ramp members 3 (e.g. a first ramp member and a second ramp member) lie parallel to, and on either side of, the parallel cross-beam 21 such that the parallel cross-beam 21 is situated equidistant between the ramp members 3. Each of the ramp members 3 are coupled to the parallel cross-beam 21 by way of the perpendicular swivel cross-shaft 11 and the swivel cross-shaft sleeve 13. The swivel cross-shaft sleeve 13 is coupled to the parallel cross-beam 21 by beam securing means 31.

Shown in FIG. 1, beam securing means 31 is an upper metal piece 36 spot welded to the swivel cross-shaft sleeve 13, a lower metal piece 38 situated below the parallel cross-beam 21, and bolts 40 securing the upper metal piece 36 and the lower metal piece 38 to the parallel cross-beam 21. However, any number of securing means may be used including, for example, welding, tying, bolting, screwing, bracketing, riveting, and clamping. The perpendicular swivel cross-shaft 11 fits rotatably inside of the swivel cross-shaft sleeve 13 such that both ends of the perpendicular swivel cross-shaft 11 extend out of both ends of the swivel cross-shaft sleeve 13. The extended ends of the perpendicular swivel cross-shaft 11 are coupled to both ramp members 3 by ramp member securing means 29.

Shown in FIG. 1, ramp member securing means 29 are “U” bolts driven through ramp members 3 and looped around the perpendicular swivel cross-shaft 11. However, any number of means including, for example, welding, tying, screwing, bracketing, riveting, and clamping may be used to secure the ramp members 3 to the perpendicular swivel cross-shaft 13.

In one embodiment, as shown in FIG. 1, springs 7 are situated at the joints formed between each of ramp members 3 and the perpendicular swivel cross-shaft 11. The perpendicular swivel cross-shaft 11 is moveably coupled to the swivel cross-shaft sleeve 13 via springs 7. Two springs 7 are coupled at either end of the swivel cross-shaft sleeve 13. The springs 7 are coupled at a first end (preferably the end closest to the middle of the vehicle hauling apparatus 1) to the swivel cross-shaft sleeve 13 by way of inner securing means 25. Shown in FIG. 1 the inner securing means 25 are clamps, however, any type of securing means is contemplated for use with the present embodiment. For example, other securing means such as, for example, welding, tying, bolting, screwing, bracketing, and riveting may be useful. At a second end of the springs 7 (preferably the end closest to the outer edges of the vehicle hauling apparatus 1), the springs 7 are coupled to the swivel cross-shaft 11 by way of outer securing means 27. Shown in FIG. 1 the outer securing means 27 are clamps, however, any type of securing means is contemplated for use with the present embodiment. For example, other securing means such as, for example, welding, tying, bolting, screwing, bracketing, and riveting may be useful.

In a preferred embodiment, the springs 7 are made of a metal. In yet another preferred embodiment, the springs 7 are high tensile and made of steel. In an alternate embodiment, the swivel cross-shaft sleeve 13 may be coupled to the ramp members 3 by way of a swivel locking mechanism (not shown) which is further described herein below.

Also attached to the parallel cross-beam 21 is perpendicular stationary cross-beam 19. The parallel cross-beam 21 and the perpendicular stationary cross-beam 19 may be coupled by any number of means including, for example, welding, tying, bolting, riveting, clamping, and bracketing. The perpendicular stationary cross-beam 19 is situated toward the front ends of ramp members 17 and is situated perpendicularly to parallel cross-beam 21 and parallel to the perpendicular swivel cross-shaft 11. Ramp members 3 are not attached to the perpendicular stationary cross-beam 19 so that the ramp members 3 may swivel up and down relative to the ground, wherein the fulcrum of the vehicle hauling apparatus 1 lies along the axis of the perpendicular swivel cross-shaft 11.

The recesses 5 are situated at the front ends of ramp members 17, e.g. the end closest to the towing vehicle (not shown) and hitching means 9. The recesses 5 are of appropriate dimensions to accommodate either the front wheels and/or back wheels of a recreational and/or utility vehicle (not shown). In a preferred embodiment, the front wheels of a recreational and/or utility vehicle (not shown) are positioned in the recesses 5 when loaded.

The front ends of ramp members 17 are elevated at the end closest to the towing vehicle (not shown). The elevated portions of the ramp members 17 are useful to stabilize the wheels of a recreational and/or utility vehicle (not shown) resting in the recesses 5. Recess cross-bars 23 which are situated in a parallel plane to the parallel cross-beam 21 are provided along the center of each of the recesses 5 to further stabilize the hauled vehicle's wheels (not shown). Recess cross-bars 23 may bow downward relative to the central axis of the vehicle hauling apparatus 1 to accommodate circular wheels of a recreational and/or utility vehicle (not shown).

Coupled to the front end of the parallel cross-beam 21, i.e. the end closest to the towing vehicle (not shown) and the recesses 5, is hitching means 9. Shown in FIG. 1, hitching means 9 is any standard hitch. The hitching means 9 may be of any size to fit into any type of hitch receiving means (not shown). In a preferred embodiment, hitching means 9 is selected from a standard class of hitches, such as, for example, Class I, Class II, Class III, and Class IV. Hitching means 9 is preferably a Class IV hitch. Hitching means 9 is coupled to parallel cross-beam 21 by any method including, for example, welding, tying, bolting, riveting, clamping, and bracketing. To ensure stability, hitching means 9 should be fastened securely to parallel cross-beam 21. In another embodiment, parallel cross-beam 21 and hitching means 9 may be molded such that hitching means 9 is a permanent feature of parallel cross-beam 21. Hitching means 9 should be locked to a towing vehicle's hitch receiving means (not shown) during use.

Looking now to the rear ends of ramp members 15, ramp member resting portions 34 are provided to increase stability in the vehicle hauling apparatus 1 while a recreational and/or utility vehicle (not shown) is being loaded thereto.

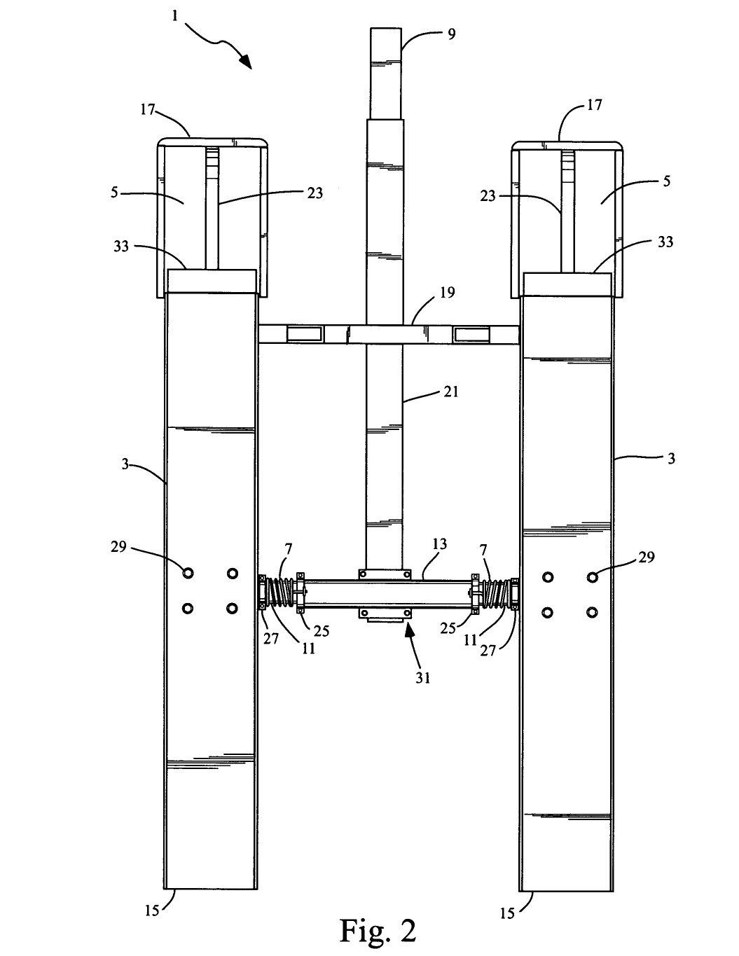

Turning now to FIG. 2, a top view of the vehicle hauling apparatus 1 of FIG. 1 is shown. Shown are the vehicle hauling apparatus 1, ramp members 3, recesses 5, springs 7, the hitching means 9, the perpendicular swivel cross-shaft 11, the swivel cross-shaft sleeve 13, rear ends of ramp members 15, front ends of ramp members 17, the perpendicular stationary cross-beam 19, the parallel cross-beam 21, recess cross-bars 23, inner securing means 25, outer securing means 27, ramp securing means 29, beam securing means 31, and ramp member extensions 33.

Shown in FIG. 2 the perpendicular swivel cross-shaft 11 is rotationally coupled to swivel cross-shaft sleeve 13 via springs 7. The outermost ends of the springs 7 are coupled to the perpendicular swivel cross-shaft 11 by way of outer securing means 27. In one embodiment, outer securing means 27 may be a clamp securely fastened around the outer perimeter of the perpendicular swivel cross-shaft 11 which is also securely fastened to the outermost end (second end) of springs 7. The innermost ends (first end) of the springs 7 are coupled to the swivel cross-shaft sleeve 13 by way of inner securing means 25. In one embodiment, inner securing means 25 may be a clamp securely fastened to the outer perimeter of the swivel cross-shaft sleeve 13 which is also securely fastened to the innermost end of springs 7. However, any means useful for coupling the springs 7 to the perpendicular swivel cross-shaft 11 and swivel cross-shaft sleeve 13, such as, for example, welding, bolting, riveting, and screwing is contemplated for use with the embodiment. In another embodiment, the outermost ends (second end) of the springs 7 may be fastened to ramp members 3 as opposed to the perpendicular swivel cross-shaft 11 by any means including, for example, welding, tying, bolting, screwing, bracketing, riveting, and clamping. In any case, the ramp members 3 and the perpendicular swivel cross-shaft 11 should move cohesively as one unit while the swivel cross-shaft sleeve 13 and parallel cross-beam 21 remain stationary as one unit. Ramp members 3 and perpendicular swivel cross-shaft 11 may achieve unity by way of ramp member securing means 29 while swivel cross-shaft sleeve 13 and parallel cross-beam 21 achieve unity by way of beam securing means 31.

Recesses 5, situated at the front ends of ramp members 17, are shown with recess cross-bars 23. The recess-cross bars 23 attach at a first end to the front ends of ramp members 17 and at a second end to ramp member extensions 33 which dip down relative to the horizontal plane of the ramp members 3. Recess cross-bars 23 are useful to secure recreational and/or utility vehicle wheels upon loading. Recess cross-bars 23 may be adapted to suit the wheel specifications of any particular recreational and/or utility vehicle being hauled. Recess cross bars 23 are useful for increasing wheel stability as well as for balancing the weight of a loaded recreational and/or utility vehicle along the horizontal plane of the vehicle hauling apparatus 1 which is situated parallel to the ground. Likewise, depending on the type of recreational and/or utility vehicle hauled as well as user preference, the recess cross-bars 23 may be removed.

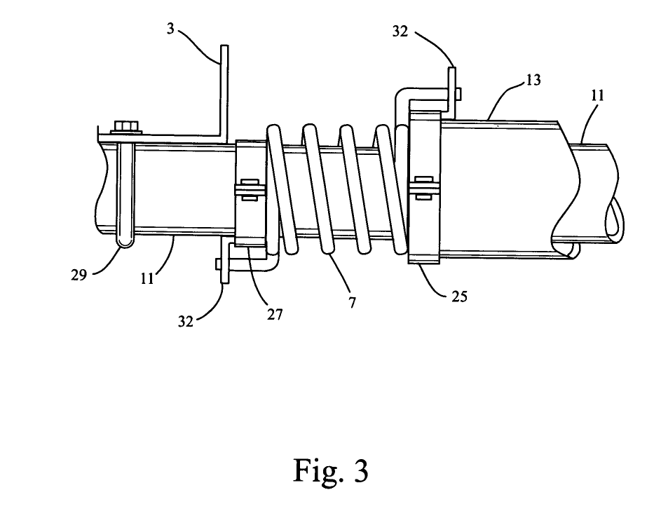

Looking now to FIG. 3, an up-close drawing of the spring 7 provided in FIG. 1 of the present embodiment is provided. Shown are a ramp member 3, the spring 7, perpendicular swivel cross-shaft 11, swivel cross-shaft sleeve 13, inner securing means 25, outer securing means 27, ramp securing means 29, and perforated tab 32.

Shown in FIG. 3 the spring 7 is fastened to outer securing means 27 at a second end and inner securing means 25 at a first end. The spring 7 may attach to the outer securing means 27 and the inner securing means 25 by way of the perforated tab 32, although any means is contemplated for use with the present embodiment. The perforated tab 32 has a hole with the approximate diameter of the diameter of spring 7. The spring 7 is bent at each end such that each end of the spring 7 may enter the perforated tab 32 of the outer securing means 27 and the inner securing means 25.

The diameter of outer securing means 27 should be of an appropriate size to securely fasten around the perpendicular swivel cross-shaft 11 whereas the diameter of inner securing means 25 should be of an appropriate size to securely fasten around the swivel cross-shaft sleeve 13. Because the perpendicular swivel cross-shaft 11 fits inside of the swivel cross-shaft sleeve 13, the diameter of the swivel cross-shaft sleeve 13 is inherently larger than the diameter of the perpendicular swivel cross-shaft 11. Therefore, the diameter of the inner securing means 25 should be of a larger diameter than the diameter of the outer securing means 27 to accommodate the difference in diameter between the swivel cross-shaft sleeve 13 and the perpendicular swivel cross-shaft 11.

The perpendicular swivel cross-shaft 11 is shown coupled to the ramp member 3 by way of ramp securing means 29. The ramp member 3 and the perpendicular swivel cross-shaft 11 are coupled such that the pieces move together as a cohesive unit. The swivel cross-shaft sleeve 13, however, is securely coupled to the parallel cross-beam (not shown) such that the pieces are stationary and do not move relative to each other.

The spring 7 functions to allow the ramp members 3, which are coupled to the perpendicular swivel cross-shaft 11 by way of outer securing means 27, to rotate relative to the stationary swivel cross-shaft sleeve 13. In a preferred embodiment, the spring 7 is a high tensile steel spring, although any metal alloy or composite thereof may be used in conjunction with the present embodiment. The tension on the spring 7 is such that in the vacant position the rear ends of ramp members (not shown) of the vehicle hauling apparatus (not shown) rest on the ground so that a vehicle may be on-loaded. As a vehicle is loaded onto the vehicle hauling apparatus (not shown), weight is initially disproportionately centered at the end of the ramp members (not shown) so that the ramp members 3 stay resting on the ground. However, as the vehicle moves closer to the front of the vehicle hauling apparatus (not shown), weight moves up along the median axis thereby overcoming the spring 7 tension and causing the springs 7 to rotate forward, thereby lifting the back end of the ramp members 3 and vehicle off the ground at a horizontal plane above the ground.

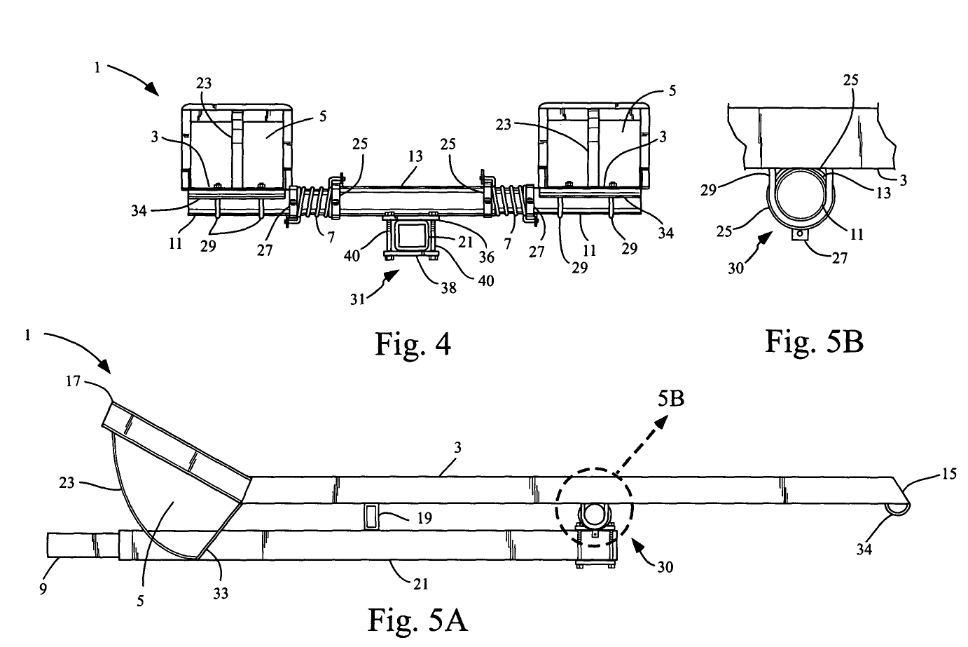

Looking now to FIG. 4 an end view of the vehicle hauling apparatus 1 of FIG. 1 is described. Shown are the vehicle hauling apparatus 1, ramp members 3, recesses 5, springs 7, the perpendicular swivel cross-shaft 11, the swivel cross-shaft sleeve 13, the parallel cross-beam 21, recess cross-bars 23, inner securing means 25, outer securing means 27, ramp member securing means 29, beam securing means 31, ramp member resting portions 34, upper metal piece 36, lower metal piece 38, and bolts 40.

Detailed in FIG. 4 is the parallel cross-beam 21 running centrally to the vehicle hauling apparatus 1. The parallel cross-beam 21 is shown coupled to the swivel cross-shaft sleeve 13 by way of the beam securing means 31. Beam securing means 31 holds the parallel cross-beam 21 stationary relative to the swivel cross-shaft sleeve 13 by way of upper metal piece 36, lower metal piece 38, and bolts 40. The upper metal piece 36 is coupled to the swivel cross-shaft sleeve by any means, such as, for example, welding, tying, bolting, screwing, bracketing, riveting, and clamping. Alternatively, upper metal piece 36 and swivel cross-shaft sleeve 13 may be molded such that the upper metal piece 36 is a permanent feature of the swivel cross-shaft sleeve 13. In any case, the parallel cross-beam 21 is situated between the upper metal piece 36 and the lower metal piece 38. The upper metal piece 36 and the lower metal piece 38 are securely fastened to the parallel cross-beam by way of bolts 40. The perpendicular swivel cross-shaft 11 is movably coupled to the swivel cross-shaft sleeve 13 by way of springs 7. Each spring 7 is held in place by way of inner securing means 25 and outer securing means 27.

Also shown in FIG. 4 are ramp securing means 29. Ramp securing means 29 couples the ramp members 3 to the perpendicular swivel cross-shaft 11, which is situated below ramp members 3. Ramp securing means 29 may be any means, such as, for example, welding, tying, bolting, screwing, bracketing, riveting, and clamping. Shown in FIG. 4, ramp securing means 29 are “U” bolts that wrap around the lower portion of the perpendicular swivel cross-shaft 11 and are secured into the ramp members 3 with nuts.

The perpendicular swivel cross-shaft 11 is shown running approximately the width of the vehicle hauling apparatus 1. The perpendicular swivel cross-shaft 11 runs through the swivel cross-shaft sleeve 13. The perpendicular swivel cross-shaft 11 is rotatably coupled to the swivel cross-shaft sleeve 13 by way of springs 7 and inner securing means 25 and outer securing means 27 as described hereinabove.

Recesses 5 are shown tipped upward relative to the perpendicular swivel cross-shaft 11 and swivel cross-shaft sleeve 13. Running through the center of recesses 5 are recess cross-bars 23 which are useful for stabilization of a recreational and/or utility vehicle (not shown) during use of the vehicle hauling apparatus 1.

Looking now to the rear of the vehicle hauling apparatus 1, ramp member resting portions 34 are shown at the opposite end of the vehicle hauling apparatus 1 than the recesses 5.

Shown in FIGS. 5A and 5B is a side view of the vehicle hauling apparatus 1 of FIG. 1. FIG. 5A details the entire vehicle hauling apparatus 1 in side elevational view, while FIG. 5B details the pivot region 30 of the vehicle hauling apparatus 1 in side view. Shown are the vehicle hauling apparatus 1, ramp member 3, recess 5, perpendicular swivel cross-shaft 11, swivel cross-shaft sleeve 13, rear ends of ramp members 15, front ends of ramp members 17, perpendicular stationary cross-beam 19, the parallel cross-beam 21, recess cross-bars 23, inner securing means 25, outer securing means 27, ramp member securing means 29, pivot region 30, ramp member extension 33, and ramp member resting portion 34.

Looking first to FIG. 5A, the vehicle hauling apparatus 1 as is situated as though a recreational and/or utility vehicle (not shown) were loaded thereto. When loaded, ramp members 3 rest on the parallel cross-beam 21 when loaded by way of the perpendicular stationary cross-beam 19 at the front of the vehicle hauling apparatus 1. The rear ends of ramp members 15 rest on the parallel cross-beam 21 by way of the components of the pivot region 30, which is further detailed in FIG. 5B. Furthermore, in the loaded state, the rear ends of ramp members 15 are elevated above ground such that the ramp member resting portions 34 are also elevated.

The recess cross-bar 23 is shown spanning the distance of the recess 5. The recess cross-bar 23 is situated between the front ends of ramp members 17 and the ramp member extensions 33. Ramp member extensions 33 may angle downward respective to ramp members 3 at angle of approximately 135° as shown. However, any angle may be utilized in conjunction with the present embodiment. In a preferred embodiment, ramp member extensions 33 are angled between 90° and 180°. Alternatively, the recess cross-bars 23 and/or ramp member extensions 33 may be removed from the vehicle hauling apparatus 1.

Turning now to FIG. 5B, the pivot region 30 of the vehicle hauling apparatus 1 of FIG. 5A is further detailed in side view. From the side perspective the perpendicular swivel cross-shaft 11 is shown innermost to the pivot region 30. Directly surrounding the perpendicular swivel cross-shaft 11 is the swivel cross-shaft sleeve 13 which is shown between the ramp member 3 and the perpendicular swivel cross-shaft 11. However, the view of the swivel cross-shaft sleeve 13 is obstructed toward the bottom of the pivot region 30 by the ramp securing means 29, which is shown as a “U” shaped bolt. Shown below the ramp securing means 29 is the inner securing means 25, which functions to rotatably secure the swivel cross-shaft sleeve 13 to the perpendicular swivel cross-shaft 11 by way of a spring (not shown). Shown below the inner securing means 29 is the perforated tab portion of the outer securing means 27, which also functions to rotatably secure the swivel cross-shaft sleeve 13 to the perpendicular swivel cross-shaft 11 by way of a spring (not shown). Importantly, other types of means are contemplated for rotatably securing the swivel cross-shaft sleeve 13 to the perpendicular swivel cross-shaft 11, such as described herein below.

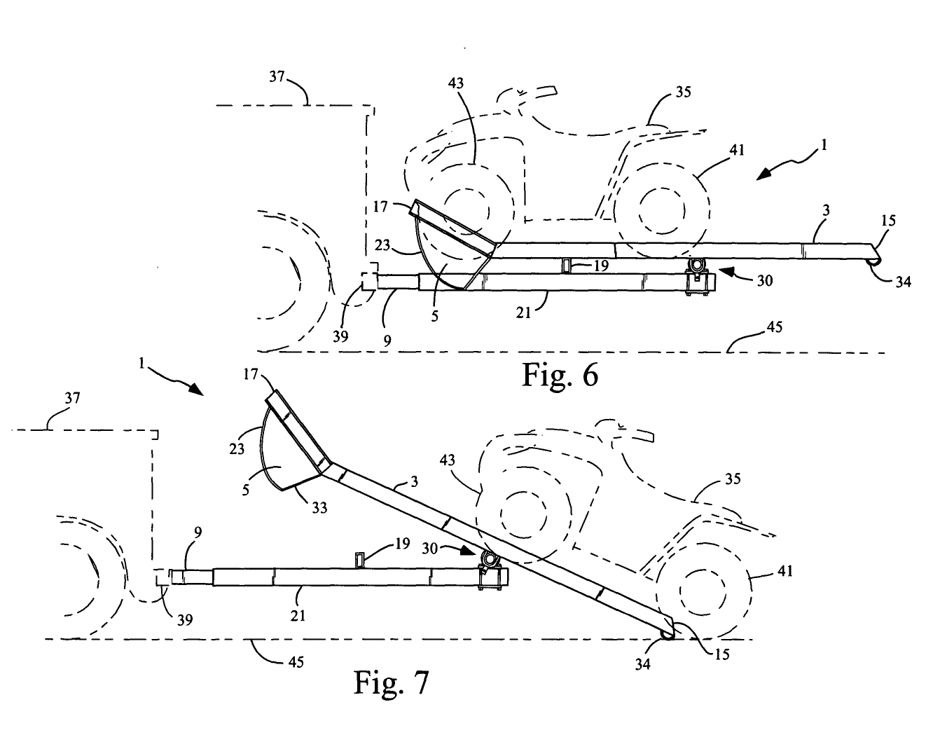

Provided in FIGS. 6 and 7 are drawings of a vehicle hauling apparatus 1 of FIG. 1 with a recreational vehicle 35 loaded thereto. FIG. 6 is directed to the loaded state while FIG. 7 is directed to end step of the unloading process. Shown are the vehicle loading apparatus 1, ramp member 3, recess 5, hitching means 9, rear end of ramp member 15, front end of ramp member 17, perpendicular stationary cross-beam 19, parallel cross-beam 21, recess cross-bar 23, pivot region 30, ramp member resting portions 34, recreational vehicle 35, towing vehicle 37, hitch receiving means 39, rear tire 41, front tire 43, and ground 45.

Shown in FIG. 6 a recreational vehicle 35 is shown loaded onto a vehicle hauling apparatus 1. Although the recreational vehicle 35 is depicted as an ATV, it should be understood that any type of recreational and/or utility vehicle may be on-loaded, hauled, and off-loaded by the present embodiment. The vehicle hauling apparatus 1 is coupled to a towing vehicle 37 by way of hitching means 9. Hitching means 9 of the vehicle hauling apparatus 1 is coupled with the hitch receiving means 39 of the towing vehicle 37. Although not shown, hitching means 9 and hitch receiving means 39 may be further coupled with lighting features (e.g. tail lights) and various types of safety harnesses (e.g. chains, ropes, springs, safety clamps).

In the vehicle hauling apparatus's 1 loaded state (as shown in FIG. 6) the ramp members 3 are situated horizontally above ground 45. As such, the recreational vehicle is situated towards the front end of ramp members 17 with the front wheels 43 of the recreational vehicle 35 resting in the recess 5. The front wheels 43 of the recreational vehicle 35 are supported by the recess 5 as well as the recess cross-bars 23. However, the recreational vehicle may, in another embodiment, be loaded such that the rear wheels 41 are situated in the recess 5.

In the loaded state, spring tension is overcome by the weight of the recreational vehicle 35 as the recreational vehicle 35 moves up along the ramp members 3 to the front of the vehicle hauling apparatus 1. As such, in the loaded state, the ramp members 3 rest on the parallel cross-beam 21 by way of the perpendicular stationary cross-beam 19 while towards the rear of the vehicle hauling apparatus 1 the ramp members 3 rest on the components of the pivot region 30 (as detailed herein above in FIG. 5B). Furthermore, in the loaded state, the rear ends of ramp members 15 are elevated above ground such that the ramp member resting portions 34 are also elevated.

Turning now to FIG. 7, the vehicle hauling apparatus 1 is shown at the last step prior to being off-loaded (likewise, this drawing also represents the first step in the on-loading process). Therefore as a recreational vehicle 35 is being on-loaded or off-loaded, the ramp members 3 are tilted towards the ground 45. Specifically, the ramp member resting portions 34 are positioned on the ground 45 such that the ramp members 3 slope at a downward angle so that the recreational vehicle 35 may exit (or enter) the vehicle hauling apparatus 1.

As the recreational vehicle's 35 weight moves from the front of the vehicle hauling apparatus 1 to the center and then rear of the vehicle hauling apparatus 1, spring tension causes the ramp members 3 to tilt towards the ground 45. As such, the ramp members 3 pivot by way of the components of the pivot region 30 (as detailed herein above in FIG. 5B) thereby causing the front ends of ramp members 17 to lift up such that the ramp members 3 no longer rest on the parallel cross-beam 21 by way of the perpendicular stationary cross-beam 19.

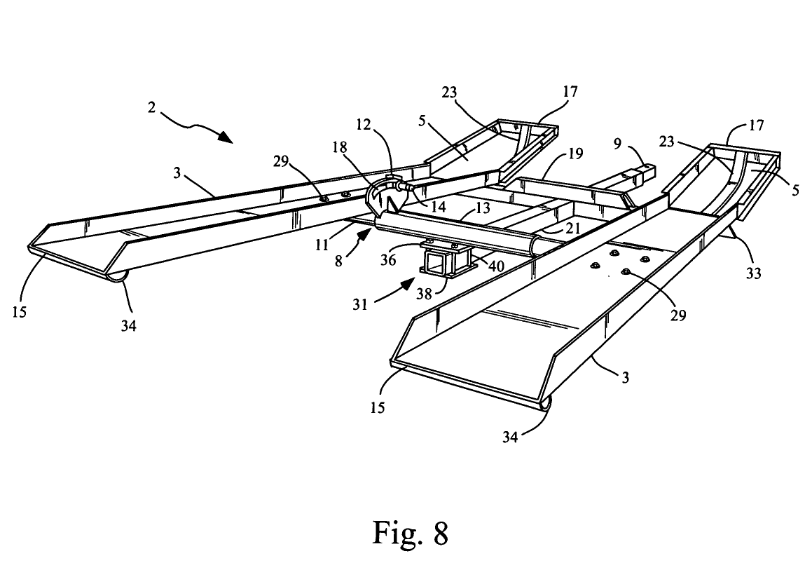

Turning now to FIG. 8 a perspective view of a vehicle hauling apparatus 2 with a swivel lock mechanism 8 is depicted. Shown are the vehicle hauling apparatus 2, ramp members 3, recesses 5, the swivel lock mechanism 8, a hitching means 9, a plate 10, a perpendicular swivel cross-shaft 11, a tab 12, a swivel cross-shaft sleeve 13, a projection 14, rear ends of ramp members 15, front ends of ramp members 17, a cut-out portion 18, a perpendicular stationary cross-beam 19, a parallel cross-beam 21, recess cross-bars 23, inner securing means 25, outer securing means 27, ramp member securing means 29, beam securing means 31, a ramp member extension 33, ramp member resting portions 34, upper metal piece 36, lower metal piece 38, and bolts 40.

The vehicle hauling apparatus 2 of FIG. 8 functions similarly to the vehicle hauling apparatus of FIG. 1 (not shown here). Likewise, many of the components of the vehicle hauling apparatus 2 of FIG. 8 are the similar to the components of the vehicle hauling apparatus 1 of FIG. 1. The vehicle hauling apparatus 2 of FIG. 8 has a swivel lock mechanism 8 as opposed to the spring mechanism shown in FIG. 1 (not shown here).

Turning now to the vehicle hauling apparatus 2 of FIG. 8, two ramp members 3 (e.g. a first ramp member and a second ramp member) lie parallel to, and on either side of, the parallel cross-beam 21 such that the parallel cross-beam 21 is situated equidistant between the ramp members 3. Each of the ramp members 3 are coupled to the parallel cross-beam 21 by way of the perpendicular swivel cross-shaft 11 and the swivel cross-shaft sleeve 13. The ramp members 3 and the perpendicular swivel cross-shaft 11 should move cohesively as one unit while the swivel cross-shaft sleeve 13 and the parallel cross-beam 21 remain stationary as one unit. Ramp members 3 and perpendicular swivel cross-shaft 11 may achieve unity by way of ramp member securing means 29 while swivel cross-shaft sleeve 13 and parallel cross-beam 21 achieve unity by way of beam securing means 31.

As previously mentioned, the swivel cross-shaft sleeve 13 is coupled to the parallel cross-beam 21 by beam securing means 31. Shown in FIG. 8, beam securing means 31 is an upper metal piece 36 spot welded to the swivel cross-shaft sleeve 13, a lower metal piece 38 situated below the parallel cross-beam 21, and bolts 40 securing the upper metal piece 36 and the lower metal piece 38 to the parallel cross-beam 21. However, any number of securing means may be used including, for example, welding, tying, bolting, screwing, bracketing, riveting, and clamping. The perpendicular swivel cross-shaft 11 is rotatably inserted through the swivel cross-shaft sleeve 13, such that both ends of the perpendicular swivel cross-shaft 11 extend out of both ends of the swivel cross-shaft sleeve 13. The extended ends of the perpendicular swivel cross-shaft 11 are coupled to both ramp members 3 by ramp member securing means 29. Shown in FIG. 8, ramp member securing means 29 are “U” bolts driven through ramp members 3 and looped around the perpendicular swivel cross-shaft 11. However, any number of means including, for example, welding, tying, screwing, bracketing, riveting, and clamping may be used to secure the ramp members 3 to the perpendicular swivel cross-shaft 13.

In one embodiment, as shown in FIG. 8, the swivel lock mechanism 8 is situated at any of the joints formed between at least one ramp member 3 and the perpendicular swivel cross-shaft sleeve 13. The plate 10 portion of the swivel lock mechanism 8 is coupled to the swivel cross-shaft sleeve 13 by any number of securing means, such as, for example, welding, tying, bolting, screwing, bracketing, riveting, and clamping. In a preferred embodiment, the swivel locking means 8 is welded to the swivel cross-shaft sleeve 13. The tab 12 portion of the swivel locking means 8 is coupled to any ramp member 3 by any number of securing means, such as, for example, welding, tying, bolting, screwing, bracketing, riveting, and clamping. However, in another embodiment, the tab 12 may-be coupled to the perpendicular swivel cross-shaft 11. In any case, coupled to the tab 12 portion is the projection 14. The projection 14 inserts through a cut-out 18 portion in the plate 10. The projection 14 may be secured relative to the cut-out 18 portion, such that the ramp members 3 may be secured in any number of positions relative to the swivel cross-shaft sleeve 13.

Attached to the parallel cross-beam 21 is the perpendicular stationary cross-beam 19. The parallel cross-beam 21 and the perpendicular stationary cross-beam 19 may be coupled by any number of means including, for example, welding, tying, bolting, riveting, clamping, and bracketing. The perpendicular stationary cross-beam 19 is situated toward the front ends of ramp members 17 and is situated perpendicularly to parallel cross-beam 21 and parallel to the perpendicular swivel cross-shaft 11. Ramp members 3 are not attached to the perpendicular stationary cross-beam 19 so that the ramp members 3 may swivel up and down relative to the ground, wherein the fulcrum of the vehicle hauling apparatus 2 lies along the axis of the perpendicular swivel cross-shaft 11.

The recesses 5 are situated at the front ends of ramp members 17, e.g. the end closest to the towing vehicle (not shown) and hitching means 9. The recesses 5 are of appropriate dimensions to accommodate either the front wheels and/or back wheels of a recreational and/or utility vehicle (not shown). In a preferred embodiment, the front wheels of a recreational and/or utility vehicle (not shown) are positioned in the recesses 5 when loaded.

The front ends of ramp members 17 are elevated at the end closest to the towing vehicle (not shown). The elevated portions of the ramp members 17 are useful to stabilize the wheels of a recreational and/or utility vehicle (not shown) resting in the recesses 5. Recess cross-bars 23 which are situated in a parallel plane to the parallel cross-beam 21 are provided along the center of each of the recesses 5 to further stabilize the hauled vehicle's wheels (not shown). Recess cross-bars 23 may bow downward relative to the central axis of the vehicle hauling apparatus 2 to accommodate circular wheels of a recreational and/or utility vehicle (not shown). Depending on the type of recreational and/or utility vehicle hauled, as well as user preference, the recess cross-bars 23 may be removed.

Coupled to the front end of the parallel cross-beam 21, i.e. the end closest to the towing vehicle (not shown) and the recesses 5, is hitching means 9. Shown in FIG. 8, hitching means 9 is any standard hitch. The hitching means 9 may be of any size to fit into any type of hitch receiving means (not shown). In a preferred embodiment, hitching means 9 is selected from a standard class of hitches, such as, for example, Class I, Class II, Class III, and Class IV. Hitching means 9 is preferably a Class IV hitch. Hitching means 9 is coupled to parallel cross-beam 21 by any method including, for example, welding, tying, bolting, riveting, clamping, and bracketing. To ensure stability, hitching means 9 should be fastened securely to parallel cross-beam 21. In another embodiment, parallel cross-beam 21 and hitching means 9 may be molded such that hitching means 9 is a permanent feature of parallel cross-beam 21. Hitching means 9 should be locked to a towing vehicle's hitch receiving means (not shown) during use.

Looking now to the rear ends of ramp members 15, ramp member resting portions 34 are provided to increase stability in the vehicle hauling apparatus 2 while a recreational and/or utility vehicle (not shown) is being loaded thereto.

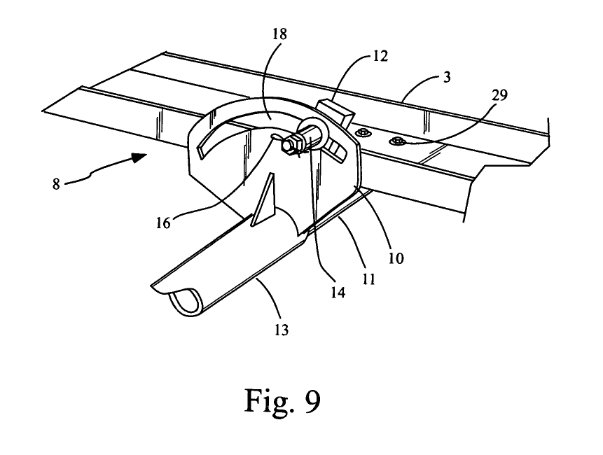

Shown in FIG. 9, an up-close drawing of the swivel lock mechanism 8 provided in FIG. 8 of the present embodiment is provided. Shown are a ramp member 3, swivel lock mechanism 8, plate 10, perpendicular swivel cross-shaft 11, tab 12, swivel cross-shaft sleeve 13, projection 14, pin 16, cut-out portion 18, and ramp securing means 29.

The swivel lock mechanism 8 connects the swivel cross-shaft sleeve 13 to ramp members 3 (or, alternatively the perpendicular swivel cross-shaft 11). Specifically, the plate 10 portion of the swivel lock mechanism 8 is coupled to the swivel cross-shaft sleeve 13 by any means described herein. The tab 12 portion of the swivel lock mechanism 8 is coupled to the ramp member 3 (or in another embodiment the perpendicular swivel cross-shaft 11) by any means described herein. The tab 12 portion has a projection 14 that slideably fits in the cut-out 18 portion of the plate 10. The projection 14 may be tightened, such that the ramp members 3 are locked in place relative to the swivel cross-shaft sleeve 13 by way of, for example, a nut of a larger diameter than the cut-out 18 portion and/or a pin 16.

Because each of the ramp members 3 are coupled to the perpendicular swivel cross-shaft 11 (by way of ramp securing means 29), the ramp members 3 and perpendicular swivel cross-shaft 11 move uniformly. The movement of the ramp members 3 and the perpendicular cross-shaft 11 is relative to the swivel cross-shaft sleeve 13 which is stationary. Therefore, when the ramp member 3 is secured by the swivel lock mechanism 8, the ramp member 3 is coupled to the perpendicular swivel cross-shaft 11. Thus, any such ramp member 3 may be locked into any of a variety of positions. In a preferred embodiment, the “on-loaded position” of a ramp member 3 is in a substantially parallel plane above ground while the “off-loaded position” of a ramp member 3 is at an angle such that the rear of the vehicle hauling apparatus (not shown) rests on the ground.

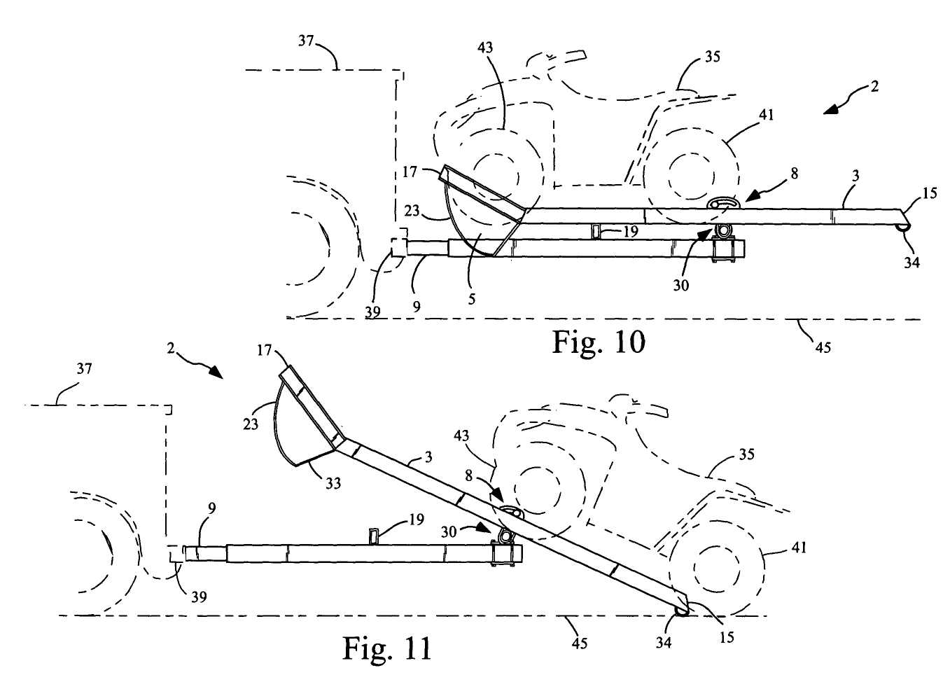

Provided in FIGS. 10 and 11 are drawings of a vehicle hauling apparatus 2 of FIG. 8 with a recreational vehicle 35 loaded thereto. FIG. 10 is directed to the loaded state while FIG. 11 is directed to end step of the unloading process. Shown are the vehicle loading apparatus 2, ramp member 3, recess 5, hitching means 9, rear end of ramp member 15, front end of ramp member 17, perpendicular stationary cross-beam 19, parallel cross-beam 21, recess cross-bar 23, pivot region 30, ramp member resting portions 34, recreational vehicle 35, towing vehicle 37, rear tire 41, front tire 43, and ground 45.

Shown in FIG. 10 a recreational vehicle 35 is shown loaded onto a vehicle hauling apparatus 2. Although the recreational vehicle 35 is depicted as an ATV, it should be understood that any type of recreational and/or utility vehicle may be on-loaded, hauled, and off-loaded by the present embodiment. The vehicle hauling apparatus 2 is coupled to a towing vehicle 37 by way of hitching means 9. Hitching means 9 of the vehicle hauling apparatus 2 is coupled with the hitch receiving means 39 of the towing vehicle 37. Although not shown, hitching means 9 and hitch receiving means 39 may be further coupled with lighting features (e.g. tail lights) and various types of safety harnesses (e.g. chains, ropes, springs, safety clamps).

In the vehicle hauling apparatus's 2 loaded state (as shown in FIG. 10) the ramp members 3 are situated horizontally above ground 45. As such, the recreational vehicle is situated towards the front end of ramp members 17 with the front wheels 43 of the recreational vehicle 35 resting in the recess 5. The front wheels 23 of the recreational vehicle 35 are supported by the recess 5 as well as the recess cross-bars 23. However, the recreational vehicle may, in another embodiment, be loaded such that the rear wheels 41 are situated in the recess 5.

In the loaded state, the swivel locking means 8 is secured such that the ramp members 3 are locked into place above ground. Furthermore, the placement of the recreational vehicle's 35 weight towards the front of the vehicle hauling apparatus 2 aids in maintaining the ramp members 3 in a horizontal plane above the ground 45. Therefore, in the loaded state, the ramp members 3 rest on the parallel cross-beam 21 by way of the perpendicular stationary cross-beam 19 while towards the rear of the vehicle hauling apparatus 1 the ramp members 3 rest on the parallel cross-beam 21 by way of the components of the pivot region 30 (i.e. perpendicular swivel cross-shaft and swivel cross-shaft sleeve). Furthermore, in the loaded state, the rear ends of ramp members 15 are elevated above ground such that the ramp member resting portions 34 are also elevated.

Turning now to FIG. 11, the vehicle hauling apparatus 2 is shown at the last step prior to being off-loaded (likewise, this drawing also represents the first step in the on-loading process). Therefore as a recreational vehicle 35 is being on-loaded or off-loaded, the ramp members 3 are tilted towards the ground 45. Specifically, the ramp member resting portions 34 are positioned on the ground 45 such that the ramp members 3 slope at a downward angle so that the recreational vehicle 35 may exit (or enter) the vehicle hauling apparatus 1.

To release the ramp members into a downward angle for on-loading or off-loading, the swivel locking means are loosened and/or unsecured. Then as the recreational vehicle's 35 weight moves from the front of the vehicle hauling apparatus 2 to the center and then rear of the vehicle hauling apparatus 2, gravity causes the ramp members 3 to tilt towards the ground 45. As such, the ramp members 3 pivot by way of the perpendicular swivel cross-shaft 11 and the swivel cross-shaft sleeve 13 thereby causing the front ends of ramp members 17 to lift up such that the ramp members 3 no longer rest on the parallel cross-beam 21 by way of the perpendicular stationary cross-beam 19.

All references cited herein are incorporated by reference.

1. A vehicle hauling apparatus, comprising:
at least one ramp member, wherein said at least one ramp member is coupled to a moveable swivel shaft; and
a swivel shaft sleeve, wherein said moveable swivel shaft is rotatably inserted through said swivel shaft sleeve; and
a beam member situated in a parallel plane to said at least one ramp member, wherein said beam member is coupled to said swivel shaft sleeve; and
at least one spring coupled at a first end to said swivel shaft sleeve and at a second end to said moveable swivel shaft, such that said ramp members pivot vertically along the axis formed by said moveable swivel shaft wherein the horizontal center of said vehicle hauling apparatus is substantially parallel to the horizontal center of a hauling vehicle.

2. The apparatus of claim 1, further comprising a hitching means.

3. The apparatus of claim 2, wherein said hitching means is a Class IV hitch.

4. The apparatus of claim 1, further comprising at least one recess at the front ends of said at least one ramp member.

5. The apparatus of claim 1, wherein said ramp member is coupled to said moveable swivel shaft by way of “U” bolts.

6. The apparatus of claim 1, wherein said at least one spring is coupled to said swivel shaft sleeve by way of a perforated tab.

7. The apparatus of claim 1, wherein said at least one spring is coupled to said moveable swivel shaft by way of a perforated tab.

8. A vehicle hauling apparatus, comprising:
at least one ramp member, wherein said at least one ramp member is coupled to a moveable swivel shaft; and
a swivel shaft sleeve, wherein said moveable swivel shaft is rotatably inserted into said swivel shaft sleeve; and
a beam member situated in a parallel plane to said at least one ramp member, wherein said beam member is coupled to said swivel shaft sleeve; and
at least one spring coupled at a first end to said swivel shaft sleeve and at a second end to said at least one ramp member, such that said ramp members pivot vertically along the axis formed by said moveable swivel shaft wherein the horizontal center of said vehicle hauling apparatus is substantially parallel to the horizontal center of a hauling vehicle.

9. The apparatus of claim 8, further comprising a hitching means.

10. The apparatus of claim 9, wherein said hitching means is a Class IV hitch.

11. The apparatus of claim 8, further comprising at least one recess at the front ends of said at least one ramp member.

12. The apparatus of claim 8, wherein said ramp member is coupled to said moveable swivel shaft by way of “U” bolts.

13. The apparatus of claim 8, wherein said at least one spring is coupled to said swivel shaft sleeve by way of a perforated tab.

14. The apparatus of claim 8, wherein said at least one spring is coupled to said at least one ramp member by way of a perforated tab.

15. The apparatus of claim 8, wherein said at least one ramp member is two ramp members.

16. A vehicle hauling apparatus, comprising:
at least one ramp member, wherein said at least one ramp member is coupled to a moveable swivel shaft; and
a swivel shaft sleeve, wherein said moveable swivel shaft is rotatably inserted through said swivel shaft sleeve; and
a beam member situated in a parallel plane to said at least one ramp member, wherein said beam member is coupled to said swivel shaft sleeve; and
at least one swivel lock mechanism coupled to at least one ramp member and to said swivel shaft sleeve, such that said ramp members pivot vertically along the axis formed by said moveable swivel shaft wherein the horizontal center of said vehicle hauling apparatus is substantially parallel to the horizontal center of a hauling vehicle.

17. The apparatus of claim 16, further comprising a hitching means.

18. The apparatus of claim 17, wherein said hitching means is a Class IV hitch.

19. The apparatus of claim 16, further comprising at least one recess at the front ends of said at least one ramp member.

20. The apparatus of claim 16, wherein said ramp member is coupled to said moveable swivel shaft by way of “U” bolts.

21. The apparatus of claim 16, wherein said swivel lock mechanism is coupled to said swivel shaft sleeve by way of a plate.

22. The apparatus of claim 16, wherein said swivel lock mechanism is coupled to said at least one ramp member by way of a tab.

23. A vehicle hauling apparatus, comprising:
at least one ramp member, wherein said at least one ramp member is coupled to a moveable swivel shaft; and
a swivel shaft sleeve, wherein said moveable swivel shaft is rotatably inserted through said swivel shaft sleeve; and
a beam member situated in a parallel plane to said at least one ramp member, wherein said beam member is coupled to said swivel shaft sleeve; and
at least one swivel lock mechanism coupled to said moveable swivel shaft and to said swivel shaft sleeve, such that said ramp members pivot vertically along the axis formed by said moveable swivel shaft wherein the horizontal center of said vehicle hauling apparatus is substantially parallel to the horizontal center of a hauling vehicle.

24. The apparatus of claim 23, further comprising a hitching means.

25. The apparatus of claim 24, wherein said hitching means is a Class IV hitch.

26. The apparatus of claim 23, further comprising at least one recess at the front ends of said at least one ramp member.

27. The apparatus of claim 23, wherein said ramp member is coupled to said moveable swivel shaft by way of “U” bolts.

28. The apparatus of claim 23, wherein said swivel lock mechanism is coupled to said swivel shaft sleeve by way of a plate.

29. The apparatus of claim 23, wherein said swivel lock mechanism is coupled to said moveable swivel shaft by way of a tab.

30. A vehicle hauling apparatus, comprising:
a first ramp member; and
a second ramp member; and
a beam member situated in a parallel plane to said first ramp member and said second ramp member; and
a swivel shaft sleeve, wherein said swivel shaft sleeve is coupled to said beam member; and
a moveable swivel shaft inserted rotatably through said swivel shaft sleeve, wherein said moveable swivel shaft is coupled to said first ramp member and said second ramp member such that said first ramp member, said second ramp member, and said moveable swivel shaft pivot as a group relative to said beam member; and
a hitching means coupled to said beam member such that the horizontal center of said vehicle hauling apparatus is substantially parallel to the horizontal center of a hauling vehicle.

31. The apparatus of claim 30, wherein said hitching means is a Class IV hitch.

32. The apparatus of claim 30, further comprising at least one recess at the front end of said first ramp member and said second ramp member.

33. The apparatus of claim 30, wherein said ramp member is coupled to said moveable swivel shaft by way of “U” bolts.

34. The apparatus of claim 30, wherein said moveable swivel shaft is coupled to said swivel shaft sleeve by way of a spring.

35. The apparatus of claim 30, wherein said moveable swivel shaft is coupled to said swivel shaft sleeve by way of a swivel lock mechanism.

36. The apparatus of claim 30, wherein said moveable swivel shaft is coupled to any of the group consisting of said first ramp member and said second ramp member by way of a spring.

37. The apparatus of claim 30, wherein said moveable swivel shaft is coupled to any of the group consisting of said first ramp member and said second ramp member by way of a pivot lock mechanism.
